(19) United States
(12) Patent Application Publication
(10) Pub. No.: US 2013/0135179 A1
(43) Pub. Date: May 30, 2013

(54) CONTROL METHOD AND DEVICE THEREOF

(71) Applicant: Hyun KO, Seoul (KR)

(72) Inventor: Hyun KO, Seoul (KR)

(21) Appl. No.: 13/650,822

(22) Filed: Oct. 12, 2012

Related U.S. Application Data
(60) Provisional application No. 61/563,602, filed on Nov. 24, 2011.

(51) Int. Cl. G09G 5/00; G06F 15/16

(52) U.S. Cl. CPC G09G 5/00; G06F 15/16
USPC 345/2.2; 709/219

(57) ABSTRACT

Provided is a method of controlling a server device for transmitting AV data being played on the server device to a client device. The method may include displaying an image at a first resolution on a display on the server device, receiving a request from a client device for the image, changing a resolution of the displayed image from a first resolution to a second resolution, displaying the image at the second resolution at the server device, capturing the image displayed on the server device, encoding the captured image, and transmitting the encoded image to the client device.

### CROSS-REFERENCE TO RELATED APPLICATION(S)

This application claims priority under to U.S. Provisional Application Ser. No. 61/563,602 filed in the United States on Nov. 24, 2011, whose entire disclosure is hereby incorporated by reference.

### BACKGROUND

1. Field

A display device and a method for controlling the same are disclosed herein.

2. Background

Display devices and methods for controlling the same are known. However, they suffer from various disadvantages.

### BRIEF DESCRIPTION OF THE DRAWINGS

The embodiments will be described in detail with reference to the following drawings in which like reference numerals refer to like elements wherein:

FIG. 1 is a block diagram illustrating a configuration of a content sharing system according to an embodiment as broadly described herein;

FIG. 2 is a block diagram illustrating a configuration of the server device of FIG. 1;

FIG. 3 is a block diagram illustrating a configuration of the client device of FIG. 1;

FIG. 4 is a flowchart of a method for controlling the display device according to an embodiment as broadly described herein;

FIGS. 5A to 5C are views of display screens illustrating a method of changing a resolution of an image displayed on a server device;

FIGS. 6A to 6C are views of display screens illustrating a latency between a server device and a client device;

FIG. 7 is a diagram of a data packet illustrating a method of encoding a portion of AV data according to an embodiment as broadly described herein; and

FIGS. 8 and 9 are views of display screens illustrating a method of controlling a server device having a dual monitor function according to an embodiment.

### DETAILED DESCRIPTION

Hereinafter, a detailed description is provided of a display device and a method for displaying a UI on the same according to various embodiments with reference to the accompanying drawings. Embodiments of the present disclosure will be described with reference to the accompanying drawings and contents therein, however, it should be appreciated that embodiments are not limited thereto.

Various terms used in this specification are general terms selected in consideration of various functions of the present disclosure, but may vary according to the intentions or practices of those skilled in the art or the advent of new technology. Additionally, certain terms may have been arbitrarily selected, and in this case, their meanings are described herein. Accordingly, the terms used in this specification should be interpreted on the basis of substantial implications that the terms have and the contents across this specification not the simple names of the terms.

As broadly disclosed and embodied herein, a method for sharing content may transmit AV data being played on a server device for playback on a client device. Digital TVs and a wire/wireless network technology may provide access to various types of content services such as real-time broadcasting, Contents on Demand (COD), games, news, video communication, or the like. The content may be provided via an Internet network connected to each home in addition to typical electronic wave media.

An example of a content service provided via an Internet network is Internet Protocol TV (IPTV). The IPTV enables transmission of various information services, video content, broadcasts, or the like, via a high-speed Internet network to an end user. Additionally, an image display device such as a digital TV may be connected to an external image display device such as, for example, another TV, a smart phone, a PC, a tablet via a wire/wireless network, or the like, so that contents being played or stored in the image display device may be shared with the external image display device.

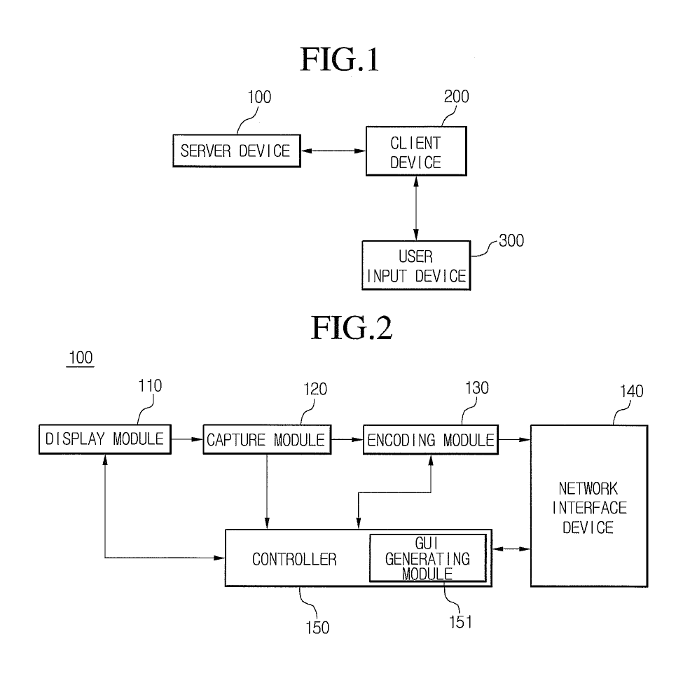

FIG. 1 is a block diagram illustrating a configuration of a content sharing system according to an embodiment as broadly described herein. The content sharing system may include a server device 100 and a client device 200. The server device 100 and the client device 200 may transmit/receive AV data over a wire/wireless network to share content. For example, as AV data being played on the server device 100 may be transmitted to the client device 200 in real time, a user may play the AV data received from the server device 100 at the client device 200. An operation on the server device 100 may be controlled from the client device using a user input device 300 connected to the client device 200. Then, the server device may be controlled by another user input device connected to the server device 100. In this case, in addition that the server device 100 is controlled by another user input device, its operation may be controlled by the user input device 300 connected to the client device 200. Accordingly, a user may control an operation of the server device 100 or the client device 200 by using another user input device connected to the server device 100 or the user input device 300 connected to the client device 200.

Moreover, an application for performing various functions such as transmission/reception, playback, control of the AV data, or the like may be installed in each of the server device 100 and the client device 200.

Additionally, the server device 100 and the client device 200 may be connected to each other to transmit/receive AV data through various communication standards such as Digital Living Network Alliance (DLNA), Wireless Lan (WiFi), Wireless HD (WIND), Wireless Home Digital Interface (WHDi), Blutooth, ZigBee, binary Code Division Multiple Access (CDMA), Digital Interactive Interface for Video & Audio (DiiVA) or another appropriate communication standard based on the desired implementation. The server device 100 and the client device 200 may be connected to a media server via a wire/wireless network such as the Internet, and may transmit/receive contents data through the media server for sharing content. Moreover, the server device 100 and the client device 200 may be a digital TV (for example, a network TV, an HBBTV, or a smart TV) or another appropriate type of device (for example, a PC, a notebook computer, a mobile communication terminal such as a smart phone, or a tablet PC).

An ‘N-screen’ service is a service that allows various devices such as a TV, a PC, a tablet PC, a smart phone, or anther appropriate type of device to continuously access a particular content through the content sharing system described with reference to FIG. 1. For example, a user may begin watching a broadcast or movie using a TV, then resume watching the same content using another device, such as a smart phone or tablet PC. Moreover, additional information associated with the content may be accessed and viewed while watching the content on the TV, phone or tablet PC.

A contents file may be shared (e.g., file share) or a screen of an image display device may be shared (e.g., screen share) between the server device 100 and the client device 200 through the above ‘N-screen’ service. For this, the server device 100 such as a PC may transmit contents received from an external device or stored therein to the client device 200, such as a TV, at the user's request through the above-mentioned communication method.

Additionally, purchased contents may be stored in the media server and may be downloaded from the media server via internet, so that the user may play the contents as desired at a chosen image display device among the server device 100 and the client device 200.

The server device 100 and the client device 200 of FIG. 1 may be wire/wirelessly connected to at least one content source and may share contents provided from the content source. For example, the content source may be a device equipped in or connected to an image display device, a Network-Attached Storage (NAS), a Digital Living Network Alliance (DLNA) server, a media server, or the like, but the present disclosure is not limited thereto.

FIG. 2 is a block diagram illustrating a configuration of the server device of FIG. 1. The server device 100 may include a display module 110, a capture module 120, an encoding module 130 (encoder), a network interface device 140, and a control unit 150 (controller). The display module 110 displays an image of AV data received from an external or stored therein according to the control of the controller 150. The audio from the AV data may be played through a sound output device.

The capture module 120 may capture an image and sound being played on the server device 100 through the display module 110 and the sound output device in order to generate AV data for transmission to the client device 200. Moreover, the encoding module 130 may encode the captured image and sound to output compressed AV data, and then, the compressed AV data outputted from the encoding module 130 may be transmitted to the client device 200 through the network interface device 140.

The network interface device 140 may provide an interface for connecting the server device 100 with a wire/wireless network including an internet network. For example, the network interface device 140 may include an Ethernet terminal for an access to a wire network, and may access a wireless network for communication with the client device 200 through WiFi, WiHD, WHDi, Blutooth, ZigBee, binary CDMA, DiiVA, Wibro, Wimax, and HSDPA communication standards.

Moreover, the network interface device 140 may receive a control signal transmitted from the client device 200. The control signal may be a user input signal to control an operation of the server device 100 through the user input device 300 connected to the client device 200. The user input device 300 may be a keyboard, a mouse, a joystick, a motion remote controller, or another appropriate type of user input interface.

For this, the network interface device 140 may include an access formation module for forming a network access for communication with the client device 200, a transmission packetizing module for packetizing the AV data outputted from the encoding module 130 according to the accessed network, and an input device signal receiving module for receiving a control signal transmitted from the client device 200.

The controller 150 may demultiplex a stream inputted from the network interface device 140, an additional tuner, a demodulator, or an external device interface device, and then, may process the demultiplexed signals in order to generate and output a signal for image or sound output.

An image signal processed in the controller 150 may be inputted to the display module 110, and then, is displayed as an image corresponding to the corresponding image signal, and a sound signal processed in the controller 150 is outputted to a sound output device. For this, although not shown in FIG. 2, the controller 150 may include a demultiplexer and an image processing unit.

Additionally, the controller 150 may further include an input signal reflecting module for performing an operation according to a control signal, which is received from a client device or a user input device directly connected to the server device 100. For example, a GUI generating unit 151 may generate a graphic user interface according to the received control signal in order to display a User Interface (UI) corresponding to the user input on the screen of the display module 110. For example, a user input inputted through the user input device 300 may be a mouse input for moving a pointer displayed on a screen, a keyboard input for displaying a letter on a screen, or another appropriate type of input.

According to an embodiment, a server device 100 as described with reference to FIGS. 1 and 2 may change a resolution of an image displayed on a display screen of display device 110 in response to a request to transfer AV data to the client device 200. The resolution may be changed to reduce the amount of time consumed for processing or transmitting the AV data. Therefore, a latency between the server device 100 and the client device 200 may be reduced.

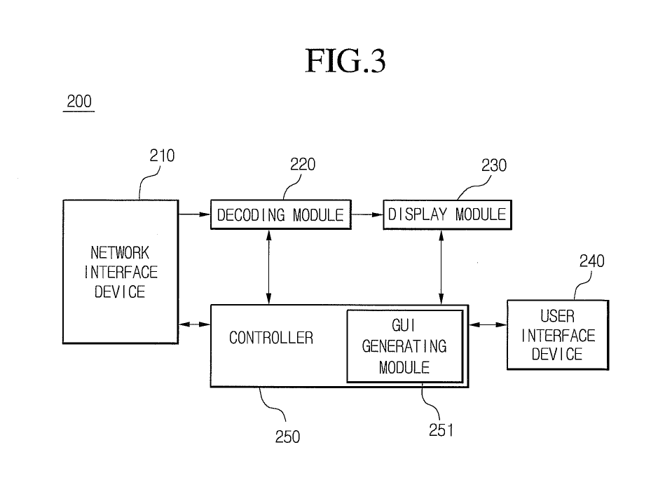

FIG. 3 is a block diagram illustrating a configuration of the client device of FIG. 1. The client device 200 may include a network interface device 210, a decoding module 220, a display module 230, a user interface 240, and a control unit 250 (controller).

The network interface device 210 may provide an interface for connecting the client device 200 to a wire/wireless network including an internet network. The network interface device 210 may also receive AV data from the server device 100 via the wire/wireless network.

The decoding module 220 may decode the AV data received from the server device 100. The decoded AV data may be reproduced on the display module 210 and a sound output device. For this, the network interface device 210 may include an access formation module for forming a network access for communication with the server device 100, and a transmission packet parser module for parsing the packetized AV data received from the server device 100.

Moreover, the user interface device 240 may receive a user input received from the user input device 300, and the controller 250 may transmit a control signal corresponding to the received user input to the server device 100 through the network interface device 210. The user input may be used to control an operation of the server device 100 from the user input device 300.

The controller 250 may demultiplex a stream inputted from the server device 100 through the network interface device 210, and may process the demultiplexed signals in order to generate and output the processed signals for outputting video and sound. An image signal processed in the controller 210 may be inputted to the display module 230, and then, may be displayed as an image corresponding to a corresponding image signal. Moreover, a sound signal processed in the controller 250 may be outputted to a sound output device. For this, although not shown in FIG. 3, the controller 250 may include a demultiplexer and an image processing module.

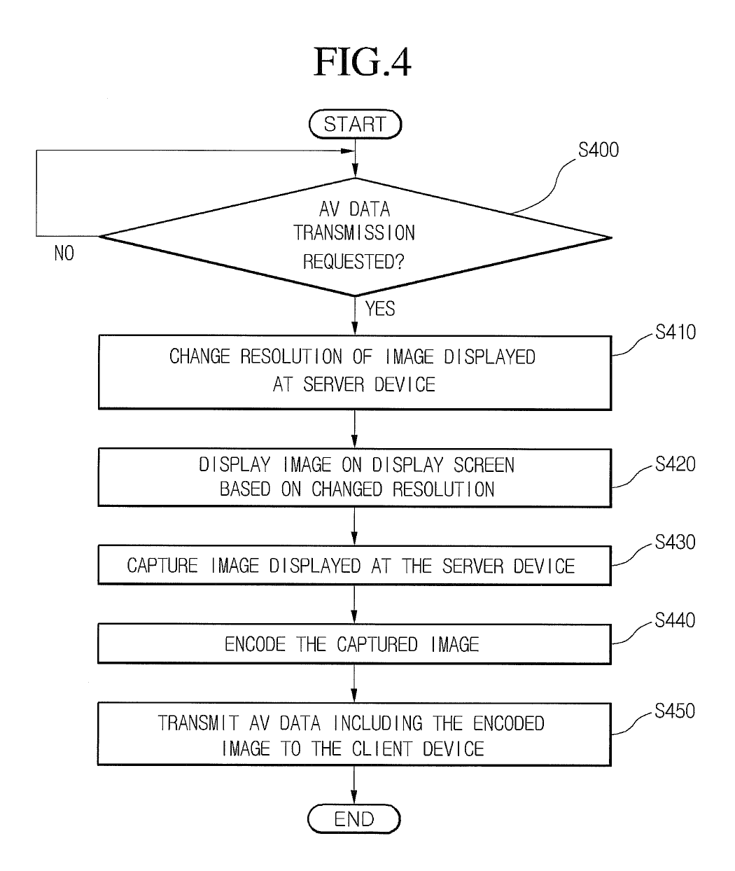

FIG. 4 is a flowchart of a method for controlling a display device according to an embodiment as broadly described herein. The method of FIG. 4 will be described with reference to the server device and client device of FIGS. 1 to 3.

The controller 150 of the server device 100 may confirm whether AV data transmission to the client device 200 is requested, in step S400, and may change a resolution of an image displayed on the display screen of the server device 100 in response to the transmission request, in step S410.

For example, when an application program for content sharing between the server device 100 and the client device 200 is executed in the server device 100 or the client device 200, the controller 150 of the server device 100 may automatically change a resolution of an image displayed at the server device 100, according to a predetermined standard.

The change in resolution of the image may be determined based on a bandwidth of the network connecting the server device 100 with the client device 200 or encoding performance of the server device 100. For example, if the server device 100 is a PC, a resolution supported by the PC may be greater than or equal to 1920×1080 (1080P). However, there may be limitations in transmitting an image having such a large resolution when considering encoding performance or network performance.

Additionally, a relatively lower resolution such as, for example, 1280×720 (720P) may be sufficient to enjoy and appreciate certain types of content such as, for example, games or videos in the server device 100 such as a PC or the client device 200 such as a TV.

Additionally, for example, in the case that the server device 100 is a TV and the client device 200 is a PC, while the TV may have a relatively lower resolution than the PC, the lower resolution of the TV (e.g., 720P) may be sufficient to enjoy and appreciate certain contents such games and videos on both the server device 100 (e.g., TV) as well as the client device 200 (e.g., PC). In this case, the resolution of the transferred AV data may be kept constant.

Accordingly, when a resolution of an image displayed on the display screen of the server device 100 is set to 1920×1080 (1080P), even if a resolution of an image transmitted to the client device 200 for display is equal to or less than 1280×720 (720P), there may be little to no limitations in sharing certain types of content. Rather, a lower resolution image may improve performance in light of network bandwidth or encoding performance capabilities.

Accordingly, when a resolution of an image displayed on the display screen of the server device 100 is set to 720P and a resolution of the client device 200 is set to 1080P, if a resolution of an image transmitted to the client device 200 is equal to 1280×720 (720P), there may be little to no limitations in content sharing, and it may provide a benefit to lower the resolution when considering network bandwidth or encoding performance. In this case, for smooth playback, the client device 200 may change its resolution setting to 720P after recognizing a resolution of a received image.

However, in order to make a resolution of an image displayed on the screen of the server device 100 different from a resolution of an image transmitted to the client device 200 for display, a resizing operation such as scaling to change the size of an image played through the display device 110 may be necessary, and such a resizing operation may be a load to the server device 100. Due to this, a latency between the server device 100 and the client device 200 may be increased.

Thus, according to an embodiment, the controller 150 of the server device 100 may change a resolution of an image displayed on the screen to correspond to a resolution of an image that is to be transmitted to the client device 200.

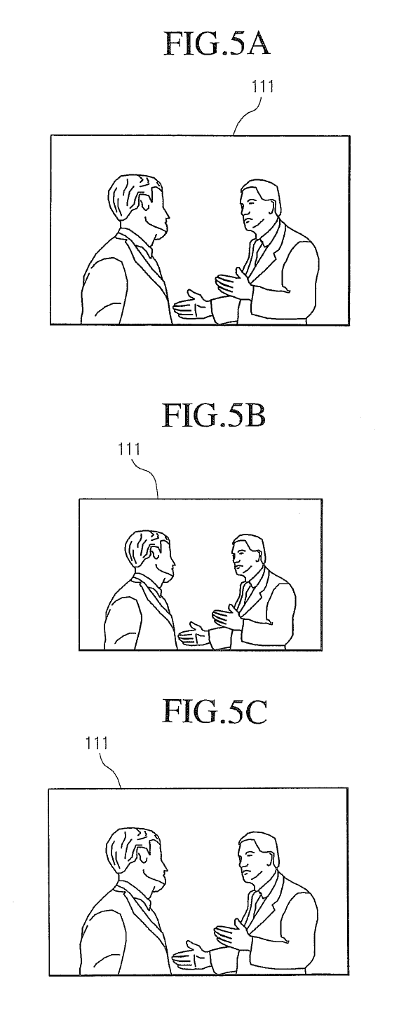

Referring to FIG. 5A, before AV data transmission is requested by a user (for example, a content sharing application program is executed in the server device 100), a resolution of an image displayed on the screen 111 of the server device 100 may be set to, for example, 1920×1080 (1080P). Then, when AV data transmission is requested by a user (for example, when a content sharing application program is executed in the server device 100), as illustrated in FIG. 5B, the controller 150 may automatically reduce a resolution of an image displayed on the display screen through the display module 110 to a lower resolution, for example, to 1280×720 (720P).

Moreover, on the contrary, when a resolution of the server device 100 is set to 720p and a resolution of the client device 200 is set to 1080P, the resolution of the server device 100 may be maintained and the resolution of the client device 200 may be automatically changed to a lower resolution. The client device 200 may recognize a resolution of an image that is to be received by a specific application, and may reduce the resolution of an image displayed to, for example, 720P on the display screen.

The display module 110 may display an image according to the changed resolution, in step S420, and the capture module 120 may capture an image displayed on the display screen, in step S430. Then, the encoding module 130 may encode the captured image, in step S440, and the network interface device 140 may transmit AV data including the encoded image to the client device 200, in step S450.

Moreover, when the transmission of AV data to the client device 200 has completed, the controller 150 may restore the resolution of the server device 100 to its previous resolution. Additionally, if a resolution of the client device 200 is changed as mentioned above, upon completion of AV data transmission, the client device 200 may automatically restore the resolution to its previous resolution.

For example, when a user enters a command to terminate the AV data transmission (for example, when an operation of a content sharing application program is terminated in the server device 100), as illustrated in FIG. 5C, the controller 150 may automatically increase a resolution of an image to a resolution that was previously set, for example, to 1920×1080 (1080P). Moreover, when AV data transmission terminates, the client device 200 may automatically increase the resolution of an image to a resolution that was previously set, for example, 1920×1080 (1080P)

Furthermore, the client device 200 may deliver a control signal corresponding to a user input received from the user input device 300 to the server device 100, and the server device 100 may operate according to the delivered control signal. Here, a predetermined amount of latency may exist from a time when the results of the operation is displayed on the server device 100 to when the results are transmitted and displayed on the client device 200. Here, the predetermined latency may include a latency caused by encoding the AV data.

For example, a network transmission delay Δt₁ (delay in, for example, encoding or transmitting AV data from the server device 100 to the client device 200), an internal streaming process routine delay Δt₂ (delay in, for example, processing the transmitted AV data in the network interface device 210 of the client device 200), and an internal decoding routine delay Δtₐ (delay in, for example, decoding the received AV data in the decoding module 220 of the client device 200) may contribute to the delay in displaying the operational results at the client device 200 from a time when the input is received at the user input device 300 (or from when the operational results are displayed at the server device 100).

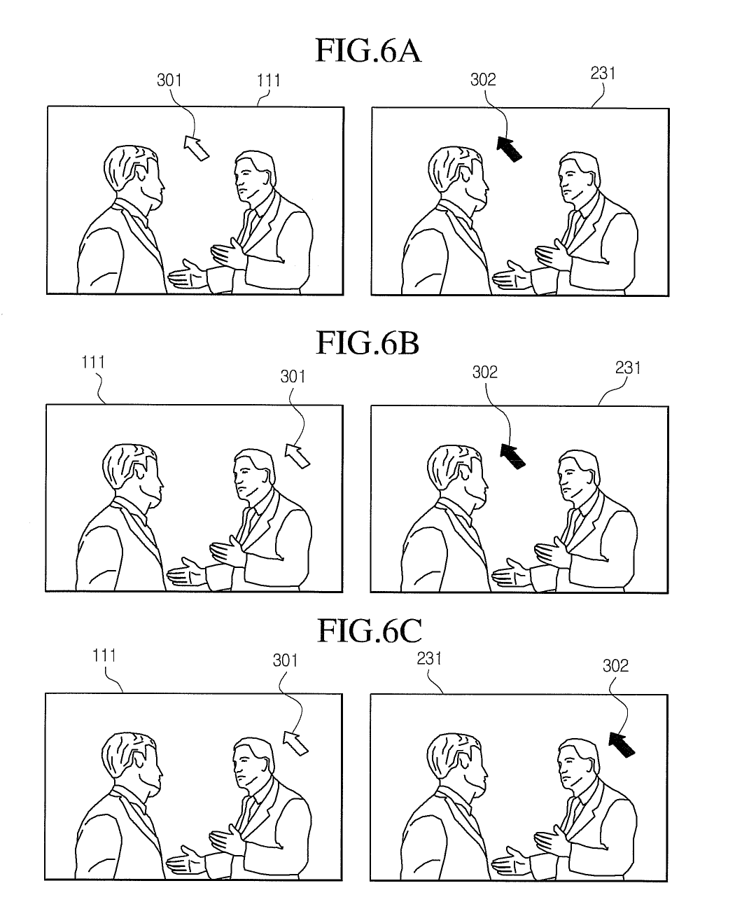

Referring to FIG. 6A, pointers 301 and 302 may be displayed on the same position of the screen 111 of the server device 100 and the screen 231 of the client device 200, respectively. Moreover, when a user moves a mouse connected to the client device 200 in order to move the pointer on the screen, as illustrated in FIG. 6B, the pointer 301 on the display screen 111 of the server device 100 may be moved immediately according to a control signal received from the client device 200. However, the pointer 302 on the display screen 231 of the client device 200 may not be moved for a predetermined amount of time due to the above-mentioned delay.

Then, after a predetermined amount of time, for example, the sum of the delay times (Δt₁+Δt₂+Δt₃), the pointer 302 on the screen 231 of the client device 200 may be moved to be synchronized with the position of the pointer 301 on the screen 111 of the server device 100, as illustrated in FIG. 6C. In one embodiment, the sum of delay times Δt₁, Δt₂ and Δt₃ may be 0.26 sec. This delay in displaying the UI at the client device 200 according to the user input may make the control of the display devices difficult.

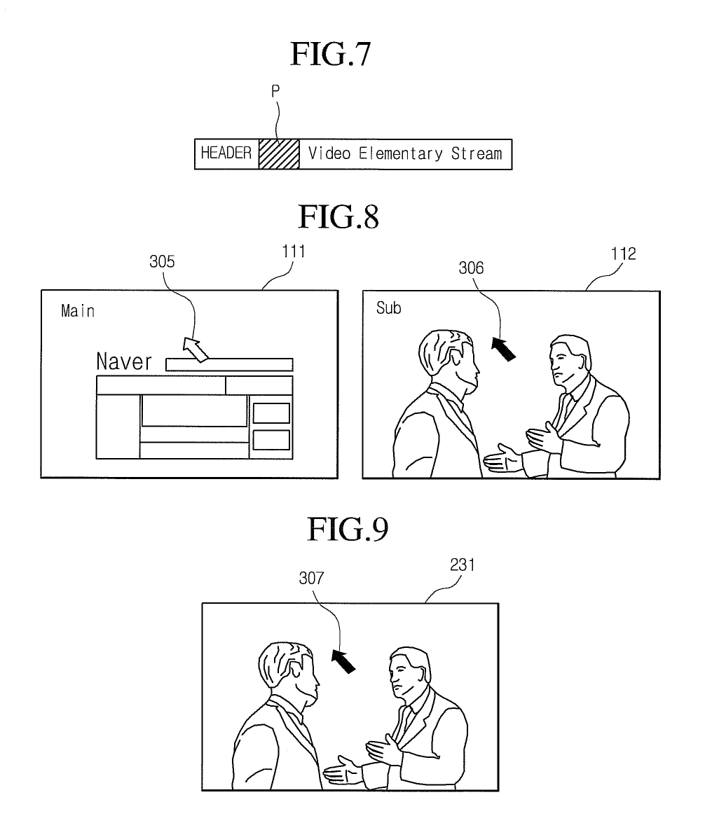

The delay between the server device 100 and the client device 200 may be reduced in various ways. According to one embodiment, the server device 100 may encode only a portion of the entire AV data transmitted to the client device 200, as described with reference to FIG. 7 hereinafter, thereby maintaining data security while also reducing latency caused by encoding the entire AV data simultaneously.

FIG. 7 is a diagram of a data packet illustrating a method of encoding AV data according to an embodiment as broadly described herein. An encoding module 130 of the server device 100 or an additional encoding module may encode a prescribed portion P of an elementary stream of the AV data transmitted to the client device 200 through a symmetric key method. The video elementary stream may be an output of the encoder 130 and may include video, audio, or caption data. The prescribed portion P of the elementary stream (e.g., video elementary stream) as illustrated in FIG. 7 may be a portion of the elementary stream that is encoded.

When the portion P of the video elementary stream is encoded, the encoding is not decoded, a portion of a display screen may be played but a distortion phenomenon may occur, so that the security of transmitted AV data may be maintained without encoding the entire AV data.

Moreover, it should be appreciated that, while the symmetric key method is described as an example to encode the portion P of the video elementary stream, the present disclosure is not limited thereto. That is, public key encoding or another appropriate type of encoding may be used in consideration of latency caused by the encoding operation.

Additionally, a transmission mode may be determined according to the types of AV data transmitted from the server device 100 to the client device 200. The transmission mode may include a first mode for improving the responsiveness and a second mode for improving an image quality. For example, when the AV data is associated with games or web browsing, a latency between the server device 100 and the client device 200 may need to be reduced in order to increase responsiveness, and hence the controller 150 may select the first mode which may increase responsiveness. For example, in the first mode, an image quality (for example, the number of frames per second) may be reduced.

Moreover, when the AV data is associated with movies, since the image quality may be more important than responsiveness after the image starts playing, the controller 150 may select the second mode in which the image quality (for example, the number of frames per second) may be improved while the responsiveness may be reduced.

According to another embodiment, the controller 150 of the server device 100 may measure a latency for AV data being played in the server device 100 to be transferred and played in the client device 200. The controller 150 may adjust an image quality of AV data transmitted to the client device 200 based on the measured latency.

For example, the latency may be obtained by synchronizing a time through a Network Time Protocol (NTP) server with respect to both sides of the server device 100 and the client device 200, or may be obtained by measuring a round trip time of a packet and a time for decoding. In this case, when the measured latency is less than a predetermined standard value, the controller 150 may increase the resolution (size of image and/or type of scan, e.g., interlaced or progressive) of an image displayed on a display screen through the display device 110 of the server device 100 or transmitted to the client device 200.

FIGS. 8 and 9 are views of display screens illustrating a method of controlling a server device having a dual monitor function according to an embodiment. In this embodiment, if the server device 100 supports a dual monitor function, one of at least two screens displayed by the server device 100 may be transmitted to the client device 200. For example, the server device 100 may display a main screen 111 and a sub-screen 112 through the display module 110. The display screens 111 and 112 may be displayed on separate monitors, or on one monitor having a divided screen (e.g., split screen function).

In this case, an image may be selected among one of the main screen 111 or the sub-screen 112 and transmitted to the client device 200. The screen image to be transmitted may be selected by a user. As illustrated in FIG. 9, the sub-screen 112 of server device 100 may be shared with the client device 200. The AV data for the image displayed on sub-screen 112 may be transmitted to the client device 200 for sharing. In this case, the main screen 111 and the sub-screen 112 may be controlled separately, for example, by different users. That is, a first user at the server device 100 may have control over the main screen 111 by using a first pointer 305, and a second user at the client device 200 may remotely control the sub-screen 112 by using a second pointer 307 at the client screen 231. That is, pointer 307 on the client screen 231 may correspond to pointer 306 on the sub-screen 112.

As broadly described and embodied herein, a content sharing function and convenience of a user using the same may be improved by reducing a latency between the server device 100 and the client device 200. Moreover, embodiments provide a method for effectively controlling a server device that transmits AV data being played at the server device to a client device, and a device using the same.

In one embodiment, a method of transmitting image data from a server device to a client device for display on the client device may include displaying an image at a first resolution on a display on the server device, receiving a request from a client device for the image, changing a resolution of the displayed image from a first resolution to a second resolution, displaying the image at the second resolution at the server device, capturing the image displayed on the server device, encoding the captured image, and transmitting the encoded image to the client device.

The resolution of the image displayed at the server device may be the same as a resolution of the image transmitted to the client device. The changing the resolution of the display image may include reducing the resolution of the image based on at least one of a network bandwidth or an encoding performance. The method may further include, when the transmission of the encoded image to the client device has terminated, restoring the resolution of the image displayed on the display of the server device.

The encoding the captured image may include encoding a portion of an AV data. The encoding the portion of the captured image may include encoding a portion of a video elementary stream of the captured image through a symmetric key method.

The method may further include determining a transmission mode based on a type of the captured image. The transmission mode may include a first mode for improving responsiveness and a second mode for improving a quality of the image displayed at the client device. The method may further include selecting the first mode when the image is associated with a game or web browsing, or selecting the second mode when the image is a movie. Moreover, the determining the transmission mode may include receiving an input to select the transmission mode for the image.

The method of this embodiment may further include measuring a latency between when the image is played at the server device and when the transmitted image is played at the client device, and adjusting an image quality of the transmitted image based on the measured latency. Moreover, a computer readable recording medium may be provided for recording a program that executes the method of claim 1 in a computer.

In one embodiment, a server device for transmitting AV data to a client device may include a display for displaying an image of the AV data, a controller for changing a resolution of an image displayed on the display in response to a request to transmit the AV data to the client device, a capture module for capturing the image displayed on the display, an encoding module for encoding the captured image, and a network interface device for transmitting the AV data including the encoded image to the client device.

The controller may reduce a resolution of the image based on at least one of a network bandwidth or an encoding performance. The controller may restore the resolution of the image displayed on the display of the server device. The encoding module may encode a portion of the transmitted AV data. The encoding module may encode a portion of a video elementary stream of the AV data through a symmetric key method.

The controller may determine a transmission mode based on a type of the AV data. The transmission mode may be selected based on an input. Moreover, the controller may adjust an image quality of the transmitted AV data based on a latency in displaying the AV data at the client device.

In one embodiment, a control method of a server device transmitting AV data being played to a client device may include changing a resolution of an image displayed on a screen of the server device in response to an AV data transmission request to the client device; displaying the image according to the changed resolution; capturing the image displayed on the screen; encoding the captured image; and transmitting AV data including the encoded image to the client device.

In another embodiment, a server device transmitting AV data to a client device may include a display unit for displaying an image of the AV data; a control unit for changing a resolution of an image displayed through the display unit in response to an AV data transmission request to the client device; a capture module for capturing the displayed image; an encoding module for encoding the captured image; and a network interface unit for transmitting AV data including the encoded image to the client device. Moreover, in one embodiment, a computer readable recording medium may be provided to record a program that executes the disclosed method in a computer.

The control method according to an embodiment of the present disclosure may be programmed to be executed in a computer and may be stored on a computer readable recording medium. Examples of the computer readable recording medium include read-only memory (ROM), random-access memory (RAM), CD-ROMs, magnetic tapes, floppy disks, and optical data storage devices.

The computer readable recording medium can also be distributed over network coupled computer systems so that the computer readable code is stored and executed in a distributed fashion. Also, functional programs, codes, and code segments for accomplishing the present disclosure can be easily construed by programmers skilled in the art to which the present disclosure pertains.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of transmitting image data from a server device to a client device for display on the client device, comprising:
displaying an image at a first resolution on a display on the server device;
receiving a request from a client device for the image;
changing a resolution of the displayed image from a first resolution to a second resolution;
displaying the image at the second resolution at the server device;
capturing the image displayed on the server device;
encoding the captured image; and
transmitting the encoded image to the client device.

2. The method of claim 1, wherein the resolution of the image displayed at the server device is the same as a resolution of the image transmitted to the client device.

3. The method of claim 1, wherein the changing the resolution of the display image includes reducing the resolution of the image based on at least one of a network bandwidth or an encoding performance.

4. The method of claim 1, further comprising, when the transmission of the encoded image to the client device has terminated, restoring the resolution of the image displayed on the display of the server device.

5. The method of claim 1, wherein the encoding the captured image includes encoding a portion of an AV data.

6. The method of claim 5, wherein the encoding the portion of the captured image includes encoding a portion of a video elementary stream of the captured image through a symmetric key method.

7. The method of claim 1, further comprising determining a transmission mode based on a type of the captured image.

8. The method of claim 7, wherein the transmission mode includes a first mode for improving responsiveness and a second mode for improving a quality of the image displayed at the client device.

9. The method of claim 8, further including selecting the first mode when the image is associated with a game or web browsing, or selecting the second mode when the image is a movie.

10. The method of claim 7, wherein the determining the transmission mode includes receiving an input to select the transmission mode for the image.

11. The method of claim 1, further comprising:
measuring a latency between when the image is played at the server device and when the transmitted image is played at the client device; and
adjusting an image quality of the transmitted image based on the measured latency.

12. A computer readable recording medium for recording a program that executes the method of claim 1 in a computer.

13. A server device for transmitting AV data to a client device, comprising:
a display for displaying an image of the AV data;
a controller for changing a resolution of an image displayed on the display in response to a request to transmit the AV data to the client device;
a capture module for capturing the image displayed on the display;
an encoding module for encoding the captured image; and
a network interface device for transmitting the AV data including the encoded image to the client device.

14. The server device of claim 13, wherein the controller reduces a resolution of the image based on at least one of a network bandwidth or an encoding performance.

15. The server device of claim 13, wherein the controller restores the resolution of the image displayed on the display of the server device.

16. The server device of claim 13, wherein the encoding module encodes a portion of the transmitted AV data.

17. The server device of claim 16, wherein the encoding module encodes a portion of a video elementary stream of the AV data through a symmetric key method.

18. The server device of claim 13, wherein the controller determines a transmission mode based on a type of the AV data.

19. The server device of claim 18, wherein the transmission mode is selected based on an input.

20. The server device of claim 13, wherein the controller adjusts an image quality of the transmitted AV data based on a latency in displaying the AV data at the client device.
